(19) United States
(12) Patent Application Publication
(10) Pub. No.: US 2019/0139703 A1
(43) Pub. Date: May 9, 2019

(54) MAGNETIC DEVICE

(71) Applicant: AJOHO ENTERPRISE CO., LTD., Taipei (TW)

(72) Inventors: Chia-Ping MO, Taipei (TW); You-Chi LIU, Taipei (TW)

(21) Appl. No.: 15/803,462

(22) Filed: Nov. 3, 2017

(51) Int. Cl. H01F 41/04; H01F 17/00; H01F 27/28; H01F 27/29; H01F 27/24

(52) U.S. Cl. CPC H01F 41/043; H01F 17/0013; H01F 27/2804; H01F 2027/2819; H01F 41/046; H01F 27/24; H01F 27/292

(57) ABSTRACT

A magnetic device includes two substrates arranged in parallel with one substrate providing one or multiple protruding block and a plurality of conductors in each protruding block and the other substrate providing a plurality of conducting contacts respectively disposed in contact with the conductors, and one or multiple magnetic cores mounted between the two substrates and coupled to the one or multiple protruding blocks, each magnetic core having one or multiple positioning slots respectively configured for receiving one respective protruding block so that the conductors and the conducting contacts are electrically connected to create with the one or multiple magnetic cores multiple induction areas for providing a continuous winding type induction coil effect.

### BACKGROUND OF THE INVENTION

### 1. Field of the Invention

The present invention relates to magnetic technologies and more particularly, to such an inexpensive magnetic device, which comprises two substrates with one providing one or multiple protruding block and a plurality of conductors in each protruding block and the other providing a plurality of conducting contacts respectively disposed in contact with the conductors, and one or multiple magnetic cores mounted between the two substrates and coupled to the one or multiple protruding blocks, each magnetic core having one or multiple positioning slots respectively configured for receiving one respective protruding block so that the conductors and the conducting contacts are electrically connected to create with the one or multiple magnetic cores multiple induction areas for providing a continuous winding type induction coil effect.

### 2. Description of the Related Art

Conventional transformers, inductors or magnetic induction components commonly comprise an iron core, two enameled wires wound round the iron cores with the four lead ends thereof respectively extended to two flanges of the iron core for connection to an external circuit for converting voltage and current and for removing magnetic waves through a grounding terminal. It takes much labor and time to wind the two enameled wires round the iron core, increasing the cost. Further, a transformer, inductor or magnetic induction component made in this manner has a large size that requires much installation space. This design does not meet the concept of the modern electronic product designs with light, thin, short, small characteristics. When multiple transformers are used in an electronic product, the electric wiring will be complicated. Therefore, there is a strong demand for improvement in the fabrication of transformers.

### SUMMARY OF THE INVENTION

The present invention has been accomplished under the circumstances in view. It is therefore the main object of the present invention to provide a magnetic device, which facilitates quick formation and saving much manufacturing cost.

To achieve this and other objects of the present invention, a magnetic device comprises a first substrate, a second substrate, and at least one magnetic core. The first and second substrates are arranged in parallel. The first substrate comprises at least one protruding block located at a bottom side thereof, and a plurality of conductors mounted in each protruding block. The second substrate comprises a plurality of conducting contacts respectively disposed in contact with the conductors of the first substrate. The at least one magnetic core is mounted between the first substrate and the second substrate and coupled to the at least one protruding block, each comprising at least one positioning slot respectively configured for receiving one respective protruding block so that the conductors and the conducting contacts are electrically connected to create with the at least one magnetic core a plurality of induction areas for providing a continuous winding type induction coil effect.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational view of a magnetic device in accordance with the present invention.

FIG. 2 is an exploded view of the magnetic device shown in FIG. 1.

FIG. 3 corresponds to FIG. 2 when viewed from another angle.

FIG. 4 is an exploded view of an alternate form of the magnetic device in accordance with the present invention.

FIG. 5 corresponds to FIG. 4 when viewed from another angle.

FIG. 6 is an oblique top elevational view of another alternate form of the magnetic device in accordance with the present invention.

FIG. 7 is an exploded view of the magnetic device shown in FIG. 6.

FIG. 8 corresponds to FIG. 7 when viewed from another angle.

FIG. 9 is a sectional view of the magnetic device shown in FIG. 6.

FIG. 10 is a schematic sectional installed view of the magnetic device shown in FIG. 6 (I).

FIG. 11 is a schematic sectional installed view of the magnetic device shown in FIG. 6 (II).

FIG. 12 is an exploded view of still another alternate form of the magnetic device in accordance with the present invention.

FIG. 13 corresponds to FIG. 12 when viewed from another angle.

FIG. 14 is a sectional exploded side view of the magnetic device shown in FIG. 12.

FIG. 15 is an exploded view of still another alternate form of the magnetic device in accordance with the present invention.

FIG. 16 is an exploded view of still another alternate form of the magnetic device in accordance with the present invention.

FIG. 17 is a sectional side view of the magnetic device shown in FIG. 16.

### DETAILED DESCRIPTION OF THE PREFERRED EMBODIMENT

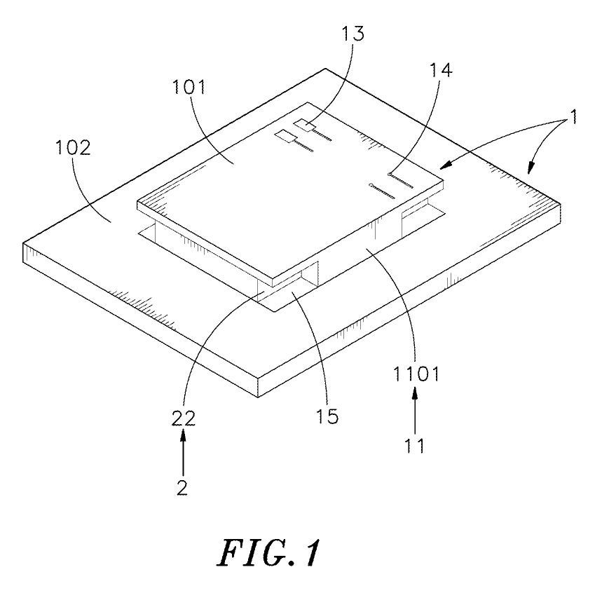

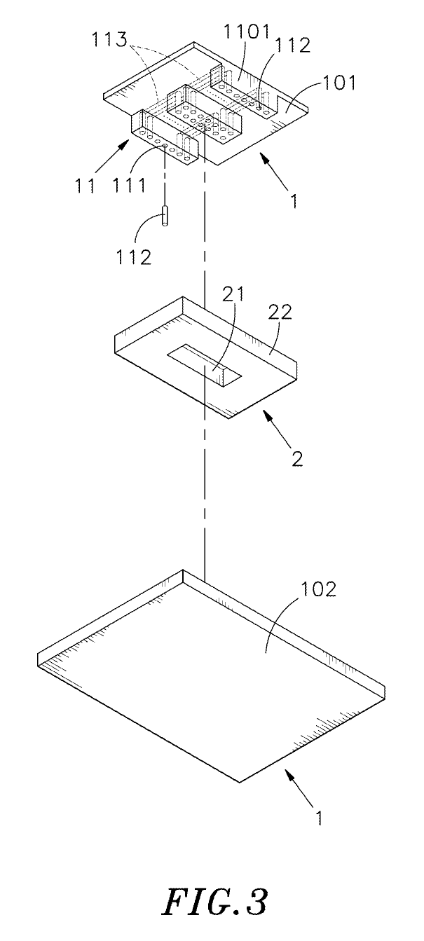

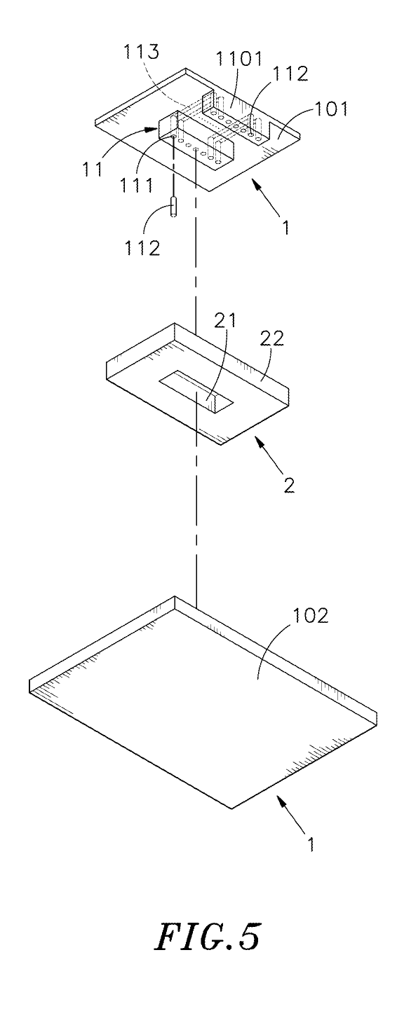

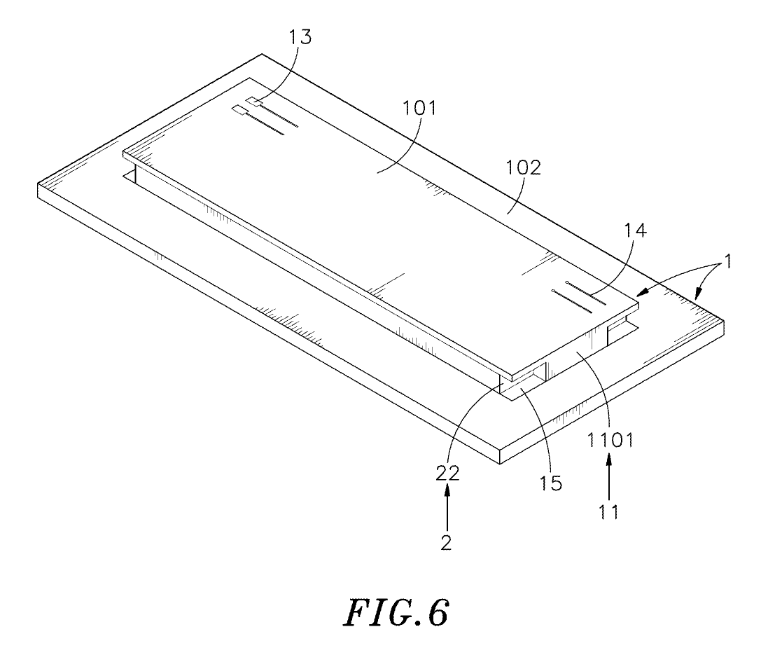

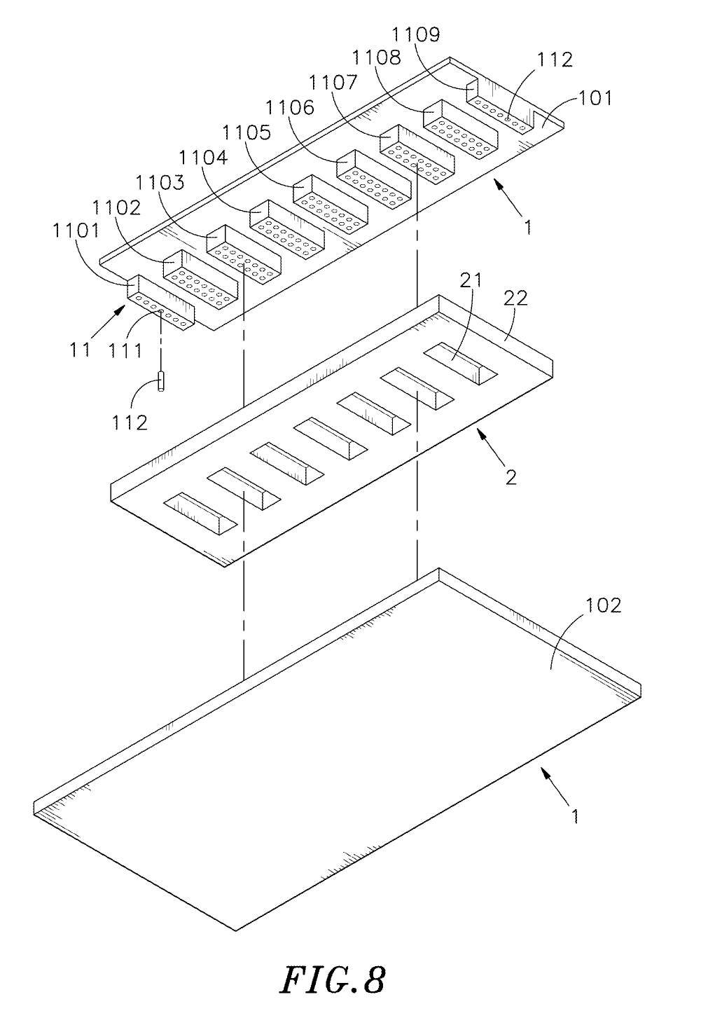

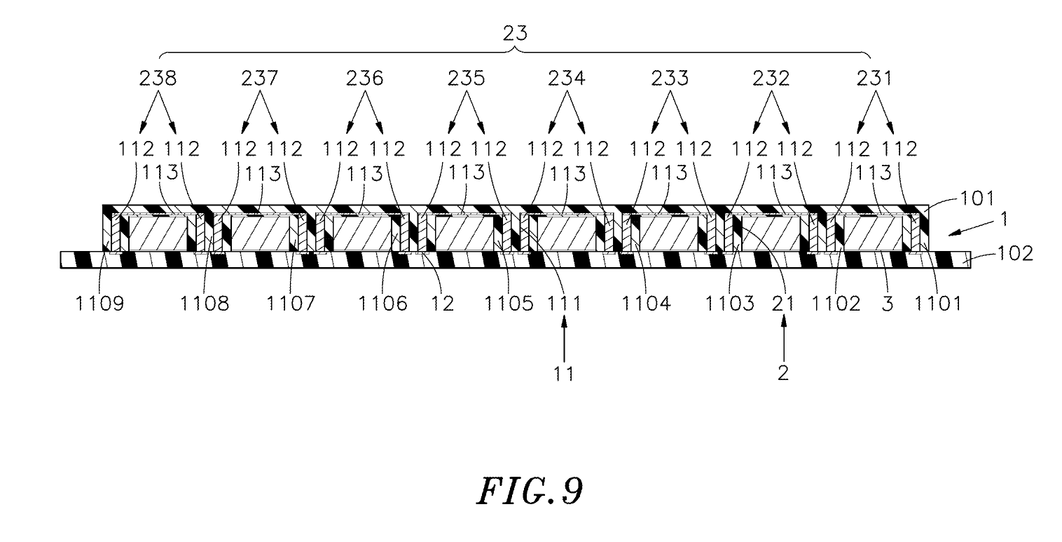

Referring to FIGS. 1-9, a magnetic device in accordance with the present invention is shown. As illustrated, the magnetic device comprises two substrates 1 and at least one magnetic core 2.

The two substrates 1 are so mechanically processed that one substrate provides at least one protruding block 11 with a plurality of recessed holes 111 and a conductor 112 mounted in each recessed hole 111, and the other substrate provides a plurality of conducting contact 12 for the contact of the respective conductors 112.

Each magnetic core 2 comprises at least one positioning slot 21, and two opposing positioning sidewalls 22 disposed at two opposite lateral sides relative to the at least one positioning slot 21.

In installation, the at least one magnetic core 2 is mounted between the two substrates 1. At this time, at least one protruding block 11 is inserted into each positioning slot 21 respectively, the two protruding blocks 11 at two opposite lateral sides are respectively abutted against the two positioning sidewalls 22. The magnetic device can be configured for use as an inductor, transformer or other magnetic induction component.

Further, the two substrates 1 can be printed circuit boards (PCBs) or flexible circuit boards, having a circuit layout arranged therein. Further, one of the two substrates 1 is configured to provide at least one input terminal 13 and at least one output terminal 14. One of the two substrates 1 is defines as the first substrate 101 that carries the at least one protruding block 11 with conductors 112 positioned in the respective recessed holes 111. The other of the two substrates 1 is defined as the second substrate 102 that carries the conducting contacts 12. The at least one input terminal 13 and the at least one output terminal 14 are arranged on a top wall of the first substrate 101. The at least one magnetic core 2 is set in between the first substrate 101 and the second substrate 102 with the at least one positioning slot 21 thereof respectively coupled to one respective protruding block 11 of the first substrate 101. Further, the at least one positioning slot 21 and the at least one protruding block 11 can be configured to exhibit a rectangular or oval shape.

Further, each protruding block 11 of the first substrate 101 is mechanically processed to provide an array of the recessed holes 111. The conductors 112 are respectively formed in the recessed holes 111 by conductor insertion, electroplating, conducting adhesive filling, circuit printing or conductor bonding. Further, the at least one protruding block 11 is formed on the first substrate 101 using milling, grinding, planing or other mechanical processing methods. Further, the first substrate 101 can be configured to provide as much as 9 protruding blocks, namely, the first protruding block 1101, the second protruding block 1102, the third protruding block 1103, the fourth protruding block 1104, the fifth protruding block 1105, the sixth protruding block 1106, the seventh protruding block 1107, the eighth protruding block 1108 and the ninth protruding block 1109. These first to ninth protruding blocks 1101˜1109 are arranged in one row with the first protruding block 1101 and the ninth protruding block 1109 disposed at two opposite lateral sides. The second protruding block 1102, the third protruding block 1103, the fourth protruding block 1104, the fifth protruding block 1105, the sixth protruding block 1106, the seventh protruding block 1107 and the eighth protruding block 1108 are equally spaced from one another between the first protruding block 1101 and the ninth protruding block 1109 in a parallel manner. After setting of the magnetic core 2 between the first substrate 101 and the second substrate 102, the first protruding block 1101 and ninth protruding block 1109 of the first substrate 101 are respectively abutted at the two opposite positioning sidewalls 22 of the magnetic core 2, holding the magnetic core 2 positively in place. The first substrate 101 is also configured to provide a conducting layer 113. One single row of conductors 112 in the first protruding block 1101 are electrically conducted with one single row of conductors 112 in the adjacent second protruding block 1102 through the conducting layer 113 to create with the at least one magnetic core 2 a first induction area 231; the other row of conductors 112 in the second protruding block 1102 is electrically conducted with the one adjacent row of conductors 112 in the third protruding block 1103 through the conducting layer 113 to create with the at least one magnetic core 2 a second induction area 232; the other row of conductors 112 in the third protruding block 1103 is electrically conducted with one adjacent row of conductors 112 in the fourth protruding block 1104 through the conducting layer 113 to create with the at least one magnetic core 2 a third induction area 233; other row of conductors 112 in the fourth protruding block 1104 is electrically conducted with one adjacent row of conductors 112 in the fifth protruding block 1105 through the conducting layer 113 to create with the at least one magnetic core 2 a fourth induction area 234; the other row of conductors 112 in the fifth protruding block 1105 is electrically conducted with one adjacent row of conductors 112 in the sixth protruding block 1106 through the conducting layer 113 to create with the at least one magnetic core 2 a fifth induction area 235; the other row of conductors 112 in the sixth protruding block 1106 is electrically conducted with one adjacent row of conductors 112 in the seventh protruding block 1107 through the conducting layer 113 to create with the at least one magnetic core 2 a sixth induction area 236; the other row of conductors 112 in the seventh protruding block 1107 is electrically conducted with one adjacent row of conductors 112 in the eighth protruding block 1108 through the conducting layer 113 to create with the at least one magnetic core 2 a seventh induction area 237; the single row of conductors 112 in the eighth protruding block 1108 are electrically conducted with the single row of conductors 112 in the ninth protruding block 1109 through the conducting layer 113 to create with the at least one magnetic core 2 an eighth induction area 238. Each induction area 23 can be formed with at least one magnetic core 2 to provide a continuous winding type induction coil effect.

Further, the second substrate 102 defines a position-limiting interval 15 for the positioning of the at least one magnetic core 2. The position-limiting interval 15 is divided into a plurality of mating connection portions, or as much as 9 mating connection portions, namely, the first mating connection portion 151, the second mating connection portion 152, the third mating connection portion 153, the fourth mating connection portion 154, the fifth mating connection portion 155, the sixth mating connection portion 156, the seventh mating connection portion 157, the eighth mating connection portion 158 and the ninth mating connection portion 159. One single row of conducting contacts 12 are arranged in each of the first mating connection portion 151 and the ninth mating connection portion 159. The second mating connection portion 152, the third mating connection portion 153, the fourth mating connection portion 154, the fifth mating connection portion 155, the sixth mating connection portion 156, the seventh mating connection portion 157 and the eighth mating connection portion 158 are properly arranged between the first mating connection portion 151 and the ninth mating connection portion 159 in a parallel manner, each having two rows of conducting contacts 12 arranged therein.

Further, the magnetic core 2 is made of a magnetic material in a rectangular shape. The magnetic material can be selected from the group of: nickel zinc, manganese zinc, amorphous or magnetic alloy materials. Further, each magnetic core 2 has opposing top and bottom surfaces thereof respectively bonded to the two substrates 1 using an adhesive 3.

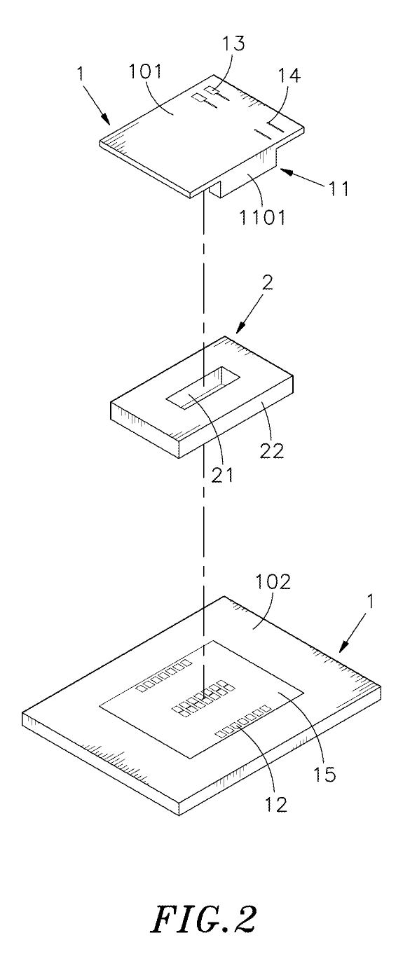

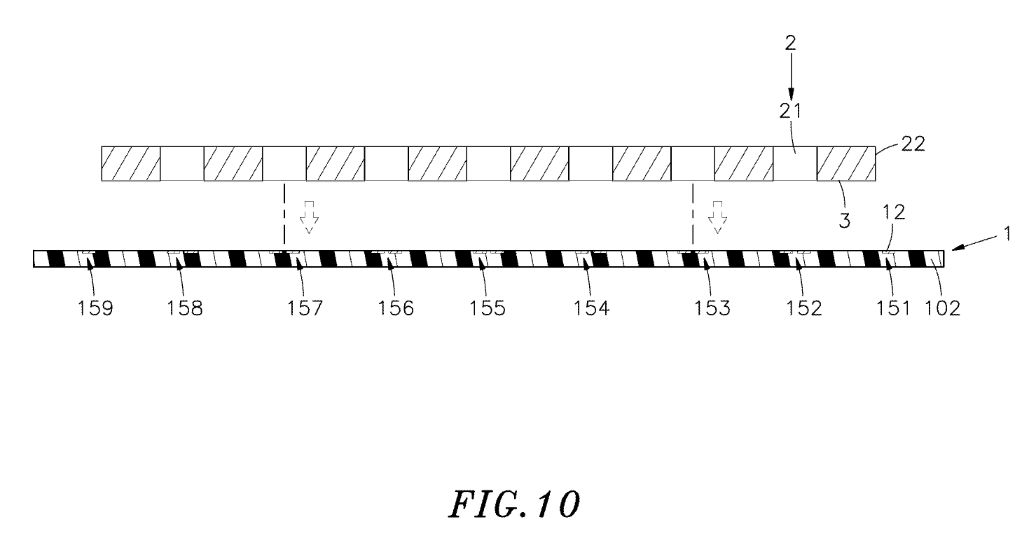

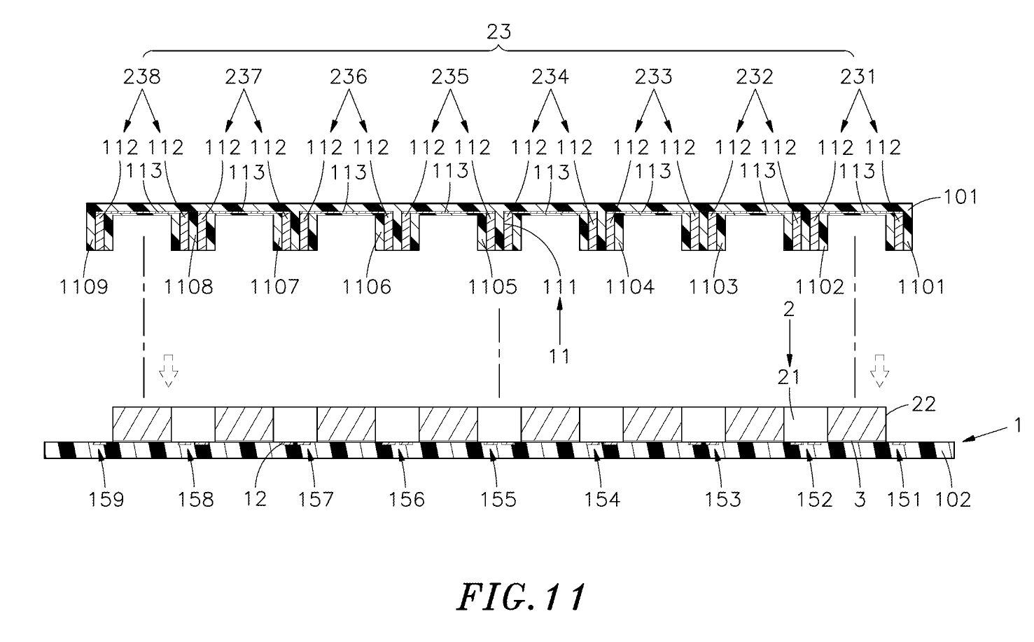

Referring to FIGS. 2, 7, 9, 10 and 11, in installation, the selected adhesive 3 is applied to the opposing top and bottom surfaces of the at least one magnetic core 2, and then the at least one magnetic core 2 is adhered to the position-limiting interval 15 of the second substrate 102 with the positioning slot 21 of each magnetic core 2 aimed at the two rows of conducting contacts 12 in one respective mating connection portion (second mating connection portion 152 to eighth mating connection portion 158) so that the single row of conducting contacts 12 at one of two opposite lateral sides within the position-limiting interval 15 is disposed outside the positioning sidewalls 22 of the at least one magnetic core 2, and then the first substrate 101 is adhered to the at least one magnetic core 2 opposite to the second substrate 102 with the at least one intermediate protruding block 11 (second protruding block 1102 to eighth protruding block 1108) respectively inserted into one respective positioning slot 21 of the at least one magnetic core 2 and the two outer protruding blocks 11 (for example, the first protruding block 1101 and the ninth protruding block 1109) abutted to the two outer positioning sidewalls 22 of the at least one magnetic core 2. Thus, the conductors 112 in the recessed holes 111 of the protruding blocks 11 (first protruding block 1101 to ninth protruding block 1109) are respectively conducted with the conducting contacts 12 in the first mating connection portion 151 to ninth mating connection portion 159 of the position-limiting interval 15 through the conducting layer 113. A surface mounting technique can be employed to electrically connect the conductors 112 and the respective conducting contacts 12, creating a plurality of induction areas 23 to provide a continuous winding type induction coil effect for rectifier or transformer application.

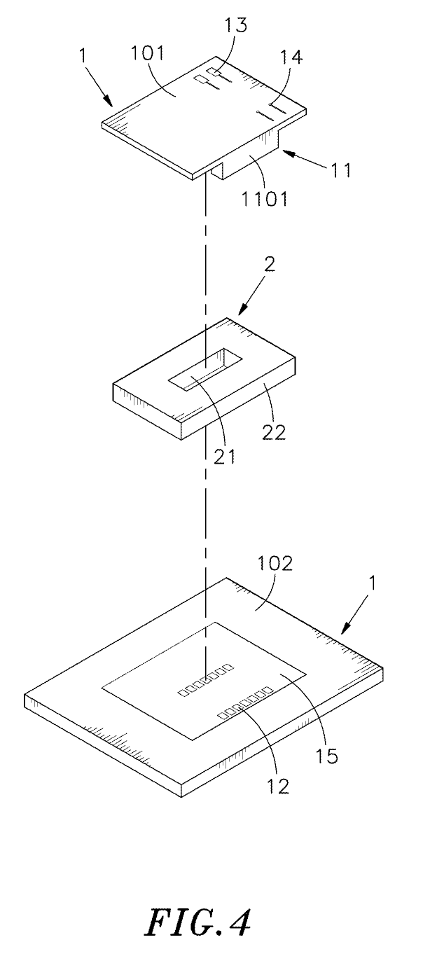

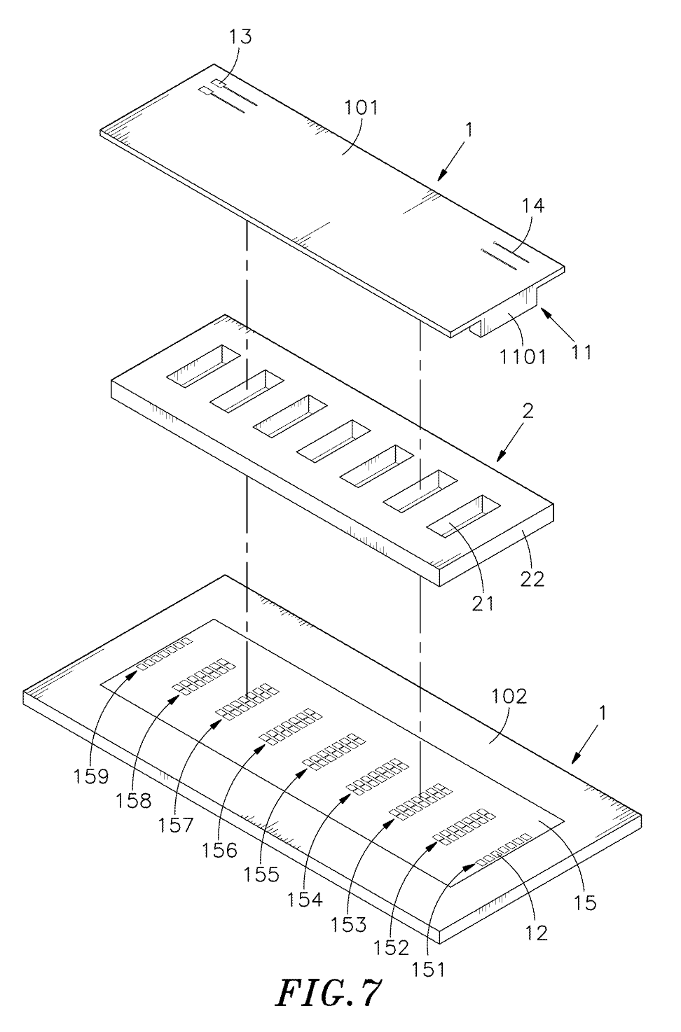

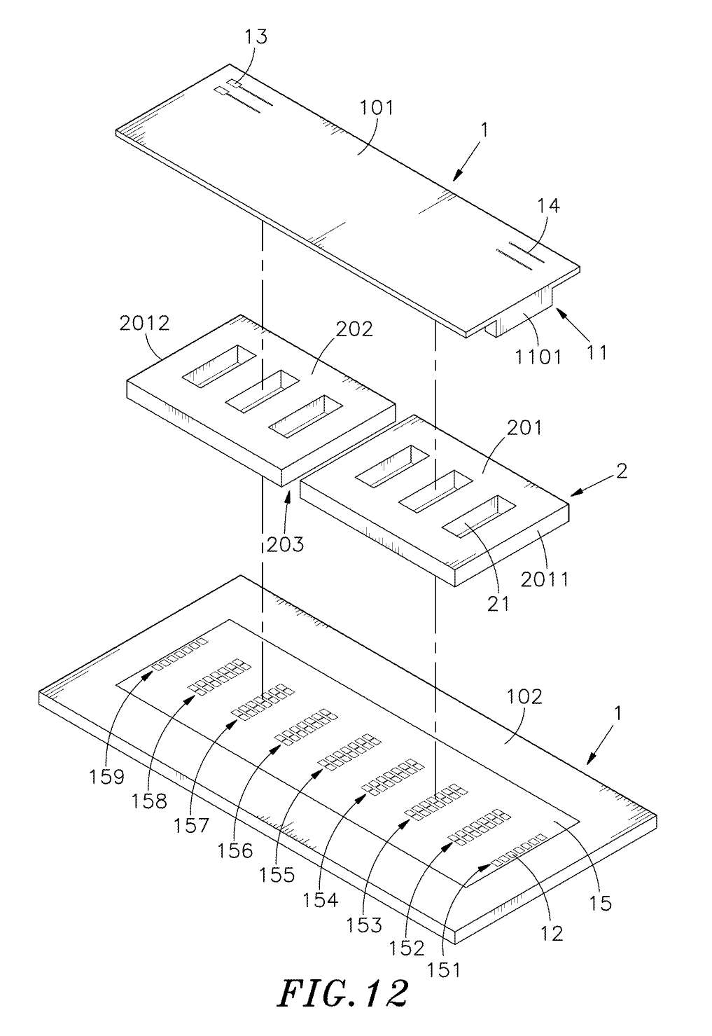

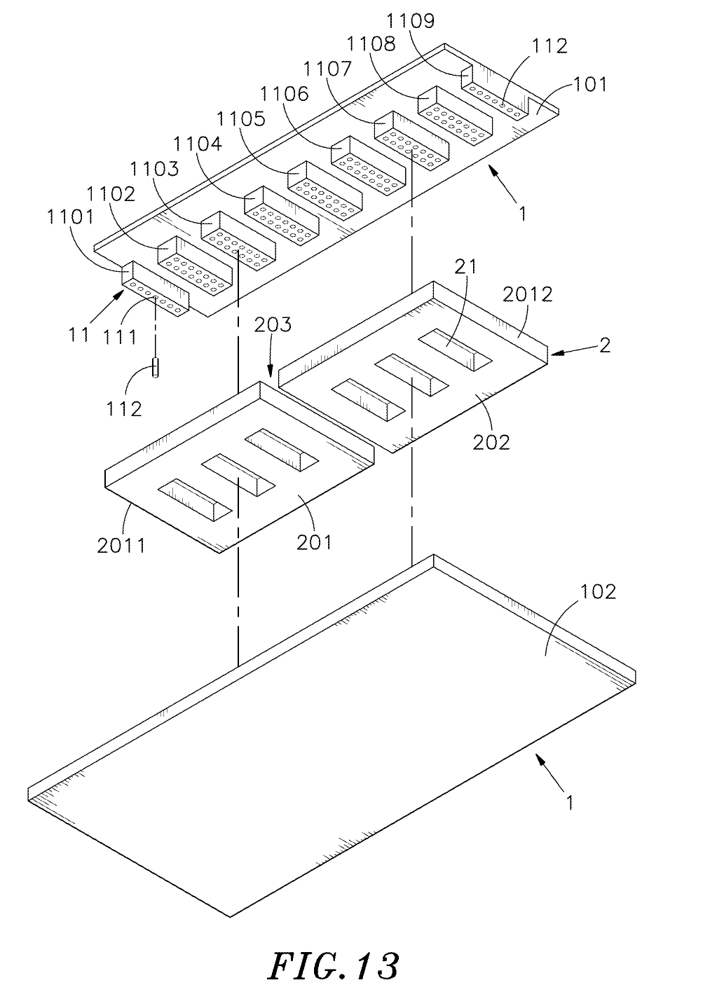

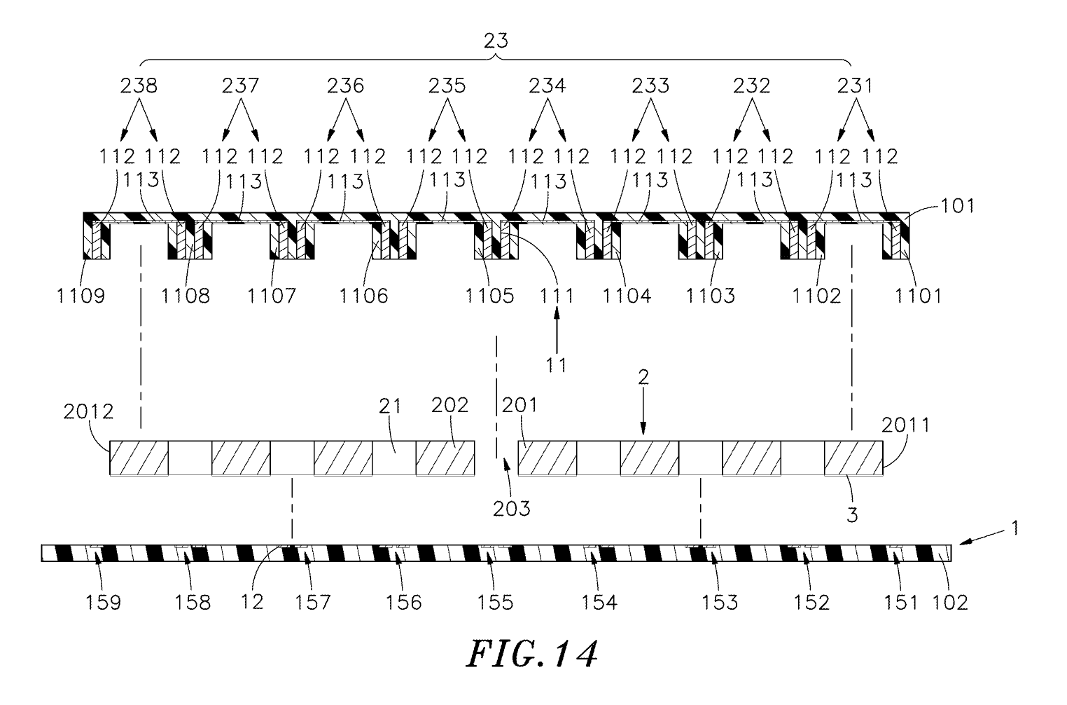

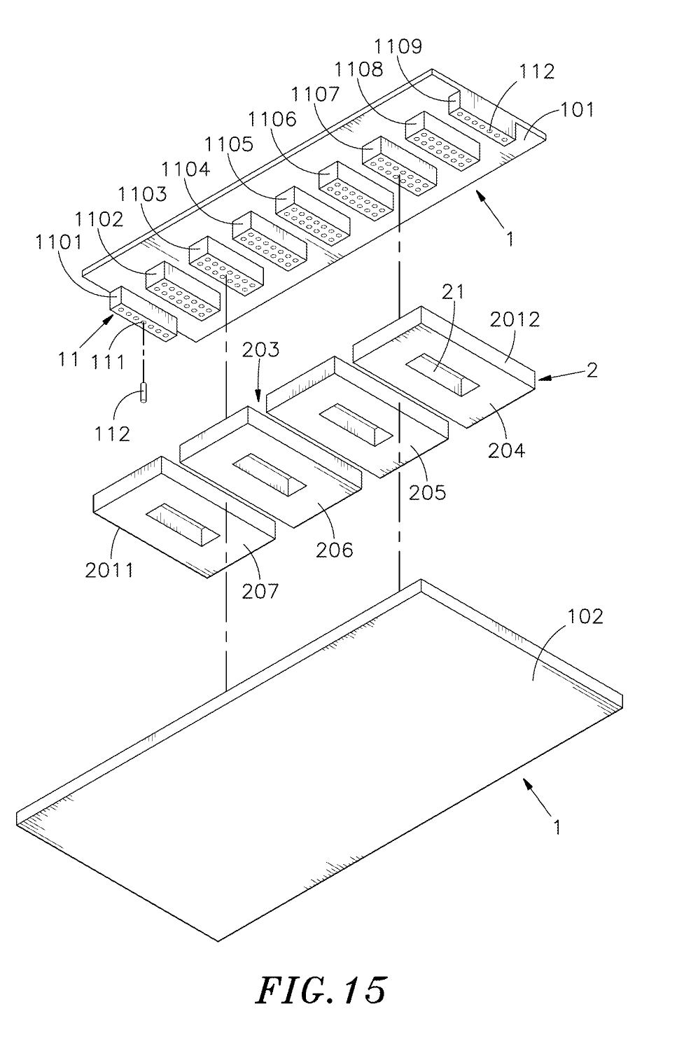

Referring to FIGS. 2, 4, 7, 12, 13, 14 and 15, the magnetic device of the present invention can be variously embodied. In the embodiments shown in FIG. 2 and FIG. 4, one single magnetic core 2 with one single positioning slot 21 is mounted between the two substrates 1. In the embodiment shown in FIG. 7, one single magnetic core 2 with multiple positioning slots 21 is mounted between the two substrates 1. In the embodiment shown in FIGS. 12-14, two magnetic cores 2 each having multiple positioning slots 21 are mounted between the two substrates 1. In the embodiment shown in FIG. 15, a plurality of magnetic cores 2 each having one single positioning slot 21 are mounted between the two substrates 1. In the embodiment shown in FIGS. 12-14, a first magnetic core 201 and a second magnetic core 202 each having 3 positioning slots 21 are mounted between the first substrate 101 and the second substrate 102 in a parallel manner. The first magnetic core 201 and the second magnetic core 202 are positioned in the position-limiting interval 15 of the second substrate 102 with the three positioning slots 21 of the first magnetic core 201 respectively aimed at the second mating connection portion 152, the third mating connection portion 153 and the fourth mating connection portion 154; the three positioning slots 21 of the second magnetic core 202 respectively aimed at the sixth mating connection portion 156, the seventh mating connection portion 157 and the eighth mating connection portion 158; the fifth mating connection portion 155 is disposed in the gap 203 between the first magnetic core 201 and the second magnetic core 202; the first mating connection portion 151 is disposed at an outer side relative to one outer first positioning sidewall 2011 of the first magnetic core 201; the ninth mating connection portion 159 is disposed at an outer side relative to one outer second positioning sidewall 2012 of the second magnetic core 202; the second protruding block 1102, third protruding block 1103 and fourth protruding block 1104 of the first substrate 101 are respectively positioned in the three positioning slots 21 of the first magnetic core 201; the sixth protruding block 1106, seventh protruding block 1107 and eighth protruding block 1108 of the first substrate 101 are respectively positioned in the three positioning slots 21 of the second magnetic core 202; the fifth protruding block 1105 is positioned in the gap 203 between the first magnetic core 201 and second magnetic core 202; the first protruding block 1101 is abutted at one outer first positioning sidewall 2011 of the first magnetic core 201; the ninth protruding block 1109 is abutted at one outer second positioning sidewall 2012 of the second magnetic core 202; the conductors 112 in the recessed holes 111 of the protruding blocks 11 (first protruding block 1101 to ninth protruding block 1109 are respectively disposed in contact with the respective conducting contacts 12 in the first through ninth mating connection portions 151˜159 to create with the first magnetic core 201 and the second magnetic core 202 a plurality of induction areas 23 for providing a continuous winding type induction coil effect.

In the embodiment shown in FIG. 15, four magnetic cores 2, namely, the third magnetic core 204, the fourth magnetic core 205, the fifth magnetic core 206 and the sixth magnetic core 207 are arranged in parallel between the two substrates 1, wherein the third magnetic core 204 is coupled to the eighth protruding block 1108 of the first substrate 101; the fourth magnetic core 205 is coupled to the sixth protruding block 1106 of the first substrate 101; the fifth magnetic core 206 is coupled to the fourth protruding block 1104 of the first substrate 101; the sixth magnetic core 207 is coupled to the second protruding block 1102 of the first substrate 101; the third protruding block 1103 is positioned in the gap 203 between the fifth magnetic core 206 and the sixth magnetic core 207; the fifth protruding block 1105 is positioned in the gap 203 between the fifth magnetic core 206 and the fourth magnetic core 205; the seventh protruding block 1107 is positioned in the gap 203 between the fourth magnetic core 205 and the third magnetic core 204. Thus, the first protruding block 1101 to the ninth protruding block 1109 are isolated from one another by the third magnetic core 204 to the sixth magnetic core 207; the conductors 112 in the protruding blocks 11 (first protruding block 1101 to ninth protruding block 1109) of the first substrate 101 are respectively disposed in contact with the respective conducting contacts 12 in the first mating connection portion 151 to ninth mating connection portion 159 of the second substrate 102 to create with third magnetic core 204 to sixth magnetic core 207 a plurality of induction areas 23 for providing a continuous winding type induction coil effect.

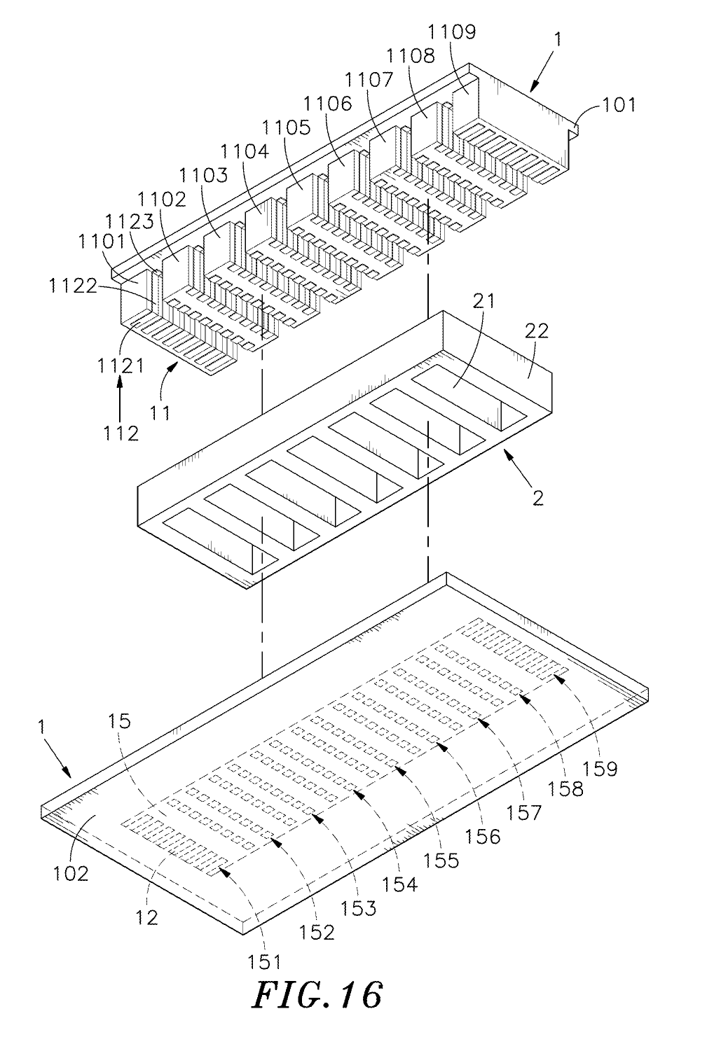

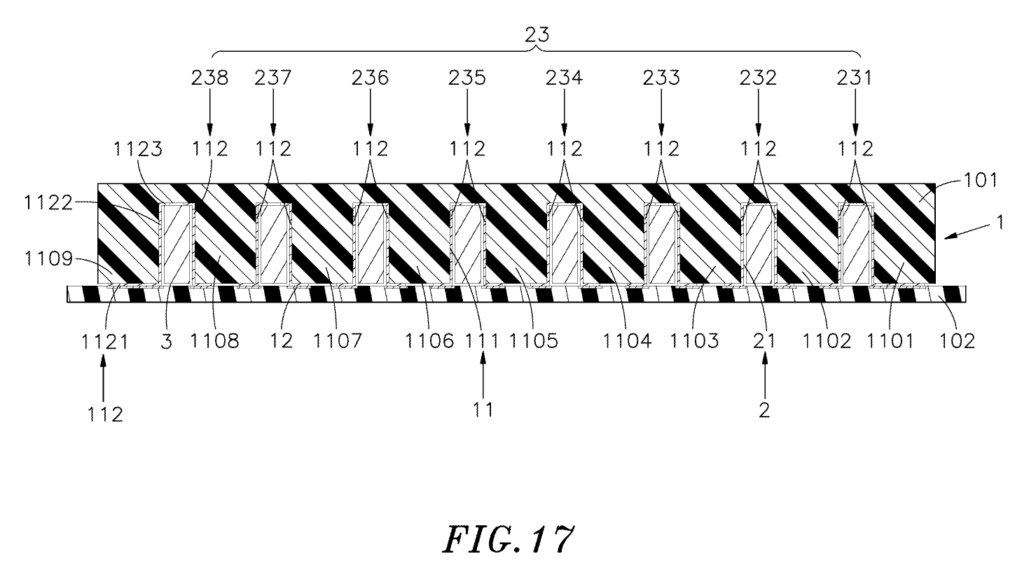

Referring to FIGS. 2, 4, 7, 16 and 17, the first substrate 101 is mechanically processed to form the first protruding block 1101 to the ninth protruding block 1109; the first protruding block 1101 and the ninth protruding block 1109 are respectively electrically plated to provide one row of conductors 112; the second to eighth protruding blocks 1102˜1108 are respectively electrically plated to provide two rows of conductors 112; the conductors 112 in the first to ninth protruding blocks 1101˜1109 each comprise a first conducting segment 1121 disposed at an outer side for direct contact with one respective conducting contact 12, a third conducting segment 1123 disposed at an inner side, and a second conducting segment 1122 connected between the first conducting segment 1121 and the third conducting segment 1123. The adhesive 3 is applied to the opposing top and bottom surfaces of each magnetic core 2 and the internal wall surface of each positioning slot 21 so that the first and second conducting segments 1121,1122 of one conductor 112 are electrically isolated from the first and second conducting segments 1121,1122 of another conductor 112, however, each magnetic core 2 is electrically connected with the third conducting segments 1123 of adjacent conductors 112, and the first conducting segments 1121 of the conductors 112 are respectively disposed in contact with the respective conducting contacts 12 of the second substrate 102, and therefore, the conductors 112 are electrically connected with the respective conducting contacts 12 to create with the at least one magnetic core 2 a plurality of induction areas 23, for example, first induction area 231, second induction area 232, third induction area 233, fourth induction area 234, fifth induction area 235, sixth induction area 236, seventh induction area 237 and eighth induction area 238 for providing a continuous winding type induction coil effect.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A magnetic device, comprising:
a first substrate and a second substrate arranged in parallel, said first substrate is mechanically processed to comprise at least one protruding block located at a bottom side of said first substrate and a plurality of conductors mounted in each said protruding block, said second substrate is mechanically processed to comprise a plurality of conducting contacts respectively disposed in contact with said conductors of said first substrate; and
at least one magnetic core mounted between said first substrate and said second substrate and coupled to said at least one protruding block, each said magnetic core comprising at least one positioning slot respectively configured for receiving one respective said protruding block so that said conductors and said conducting contacts are electrically connected to create with said at least one magnetic core a plurality of induction areas for providing a continuous winding type induction coil effect.

2. The magnetic device as claimed in claim 1, wherein said first substrate and said second substrate are respectively and selectively made in the form of a printed circuit board or flexible circuit board, each having a circuit layout arranged therein; said substrate further comprises at least one input terminal and at least one output terminal located at a top side thereof opposite to said at least one protruding block; said conductors are selectively formed in respective recessed holes in said at least one protruding block by conductor insertion, electroplating, conducting adhesive filling, circuit printing or conductor bonding; said at least one protruding block is formed on said first substrate using one of milling, grinding, planing techniques and each said protruding block is equally spaced from one another.

3. The magnetic device as claimed in claim 1, wherein said first substrate and said second substrate are selectively made in the form of printed circuit boards or flexible circuit boards, each having a circuit layout arranged therein; said first substrate further comprises at least one input terminal and at least one output terminal located at a top side thereof opposite to said at least one protruding block; said first substrate is configured to provide a plurality of said protruding blocks that are equally spaced from one another; said conductors are formed in a surface, an opposing inner side and an inner bottom surface of each said protruding block by electroplating.

4. The magnetic device as claimed in claim 1, further comprising an adhesive applied to opposing top and bottom surface of each said magnetic core and adhered to said first substrate and said second substrate.

5. The magnetic device as claimed in claim 1, wherein said first substrate is mechanically processed to create a plurality of said protruding blocks using one of milling, grinding and planing techniques, the multiple said protruding blocks being arranged in parallel with a predetermined gap defined between each two adjacent said protruding blocks, said first substrate being mechanically processed to provide a plurality of recessed holes for creating said conductors using one of conductor insertion, electroplating, conducting adhesive filling, circuit printing and conductor bonding techniques; said first substrate further comprises at least one input terminal and at least one output terminal located at an opposing top side thereof; one or multiple magnetic cores mounted between said first substrate and said second substrate and each said magnetic core comprises at least one positioning slot respectively coupled to one respective said protruding block of said first substrate.

6. The magnetic device as claimed in claim 5, wherein said first substrate is configured to provide a plurality of protruding blocks numbered from first to ninth with said first protruding block disposed at one lateral, said ninth protruding block disposed at an opposite lateral side and said second protruding block to said eighth protruding block equally spaced between said first protruding block and said ninth protruding block, said first protruding block and said ninth protruding block each having one row of said conductors arranged therein, said protruding blocks number from the second to the eighth each having two rows of said conductors arranged therein, said at least one magnetic core providing 7 said positioning slots for receiving the said protruding blocks numbered from the second to the eighth protruding block and two positioning sidewalls respectively abutted at the first said protruding block and the ninth said protruding block.

7. The magnetic device as claimed in claim 6, wherein the single row of said conductors in said first protruding block are electrically conducted with one single row of conductors in the adjacent said second protruding block through said conducting layer to create with said at least one magnetic core a first induction area; the other row of said conductors in said second protruding bloc is electrically conducted with one adjacent row of said conductors in said third protruding block through said conducting layer to create with said at least one magnetic core a second induction area; the other row of said conductors in said third protruding block is electrically conducted with one adjacent row of conductors in said fourth protruding block through said conducting layer to create with said at least one magnetic core a third induction area; the other row of said conductors in said fourth protruding block is electrically conducted with one adjacent row of said conductors in said fifth protruding block through said conducting layer to create with said at least one magnetic core a fourth induction area; the other row of said conductors in said fifth protruding block is electrically conducted with one adjacent row of said conductors in said sixth protruding block through said conducting layer to create with said at least one magnetic core a fifth induction area; the other row of said conductors in said sixth protruding block is electrically conducted with one adjacent row of said conductors in said seventh protruding block through said conducting layer to create with said at least one magnetic core a sixth induction area; the other row of said conductors in said seventh protruding block is electrically conducted with one adjacent row of said conductors in said eighth protruding block through said conducting layer to create with said at least one magnetic core a seventh induction area; the single row of said conductors in said eighth protruding block are electrically conducted with the single row of said conductors in said ninth protruding block through said conducting layer to create with said at least one magnetic core an eighth induction area; each said induction area is formed with said at least one magnetic core to provide a continuous winding type induction coil effect.

8. The magnetic device as claimed in claim 5, wherein said second substrate defines a position-limiting interval for the positioning of said at least one magnetic core, said position-limiting interval being divided into a plurality of mating connection portions numbered from the first to the ninth, one single row of said conducting contacts being arranged in each of said first mating connection portion and said ninth mating connection portion, said second mating connection portion, said third mating connection portion, said fourth mating connection portion, said fifth mating connection portion, said sixth mating connection portion, said seventh mating connection portion and said eighth mating connection portion being properly arranged between said first mating connection portion and said ninth mating connection portion in a parallel manner, the said mating connection portions from second to eighth each having two rows of said conducting contacts arranged therein.
